(19) United States
(12) Patent Application Publication
(10) Pub. No.: US 2026/0250526 A1
(43) Pub. Date: Aug. 27, 2026

(54) COATING COMPOSITION AND METHOD FOR MANUFACTURING THE SAME

(71) Applicant: Dmytro Ostapenko, Boca Raton, FL (US)

(72) Inventor: Dmytro Ostapenko, Boca Raton, FL (US)

(21) Appl. No.: 19/545,176

(22) Filed: Feb. 20, 2026

Related U.S. Application Data
(60) Provisional application No. 63/761,178, filed on Feb. 21, 2025.

(51) Int. Cl. C09D 7/40; C09D 7/41; C09D 7/61; C09D 7/65

(52) U.S. Cl. CPC C09D 7/70; C09D 7/41; C09D 7/61; C09D 7/65; C09D 7/69

(57) ABSTRACT

A lightweight waterborne coating composition exhibiting thermal insulation properties and adhesion to mineral and non-mineral substrates is disclosed. The composition includes a binder, a filler system combining high density inorganic filler and low-density organic filler in a mass ratio of 0.95:1 to 1:5.5, thinner, and interfacial additive system. The composition achieves a bulk density of 0.60-0.90 g/cm³ and viscosity of 130-140 KU, forming a flexible cured coating that passes a 1 mm mandrel bend test without cracking. The low-density organic filler enables reduced weight while maintaining thermal properties and mechanical integrity. Sequential mixing steps in the manufacturing method prevent damage to the hollow particulate material of the low-density organic filler.

### CROSS-REFERENCE TO RELATED APPLICATIONS

This application claims the benefit of U.S. Provisional Appln. No. 63/761,178 filed Feb. 21, 2025.

### FIELD OF THE INVENTION

The present invention relates to a coating composition, more particularly, to a coating composition with thermal insulation properties, and to a method of producing thereof.

### BACKGROUND OF THE INVENTION

Energy efficiency has become a central concern in modern construction, transportation, industrial equipment insulation, and energy infrastructure. A significant portion of global energy consumption is associated with heating and cooling of buildings and industrial equipment. Traditional thermal insulation materials, such as mineral wool, foam boards, or multilayer assemblies, often require substantial thickness, mechanical fastening, and complex installation procedures.

Surface-applied coating compositions with thermal insulation properties have been developed to address certain of these considerations. Such compositions may be applied by spraying, rolling, or brushing onto a substrate and are designed to reduce heat transfer while maintaining reduced thickness and applicability to substrates having complex or irregular surface geometries. However, certain coating compositions may require high filler loading to achieve thermal insulation properties, which may negatively impact rheological and application characteristics of the coating composition and may reduce mechanical integrity and adhesion performance of the cured coating obtained therefrom.

Chinese Patent Application No. CN106349855A (publication date 25.10.2022) discloses a composition with thermal insulation properties and a preparation method thereof. The disclosed composition includes sand as a filler component for exterior architectural applications. The composition as disclosed has a high solids content.

Coating compositions that provide effective thermal insulation properties while maintaining structural properties suitable for diverse applications remain desirable.

### SUMMARY OF THE INVENTION

The present invention is directed to a coating composition with thermal insulation properties exhibiting adhesion to at least two different classes of mineral and non-mineral substrates. The composition achieves this through a balanced formulation that combines an optimized filler system with a controlled binder content.

The composition comprises a binder in an amount of 29 to 50 percent by mass, a filler system in an amount of 17 to 45 percent by mass, a thinner in an amount of 9 to 30 percent by mass, an interfacial additive system in an amount 0.9 to 7% percent by mass, which can include an adhesion promoter in an amount of 0.09 to 1.1 percent by mass, a dispersant in an amount of 0.09 to 1 percent by mass, a wetting agent in an amount of 0.04 to 1 percent by mass, a thickener in an amount of 0.3 to 4 percent by mass, a rheology modifier in an amount of 0.2 to 2 percent by mass. The composition may optionally include 0 to 30 percent by mass pigment and 0 to 10 percent by mass other additives selected from biocide, preservative, pigment, defoamer, buffer, coalescent, and rust inhibitor.

The invention further provides a method of producing the coating composition.

### DETAILED DESCRIPTION OF THE INVENTION

For purposes of the present disclosure, the following terms have the meanings set forth below.

The term “coating composition” refers to an uncured, flowable formulation capable of being applied to a substrate and forming a continuous adherent film upon drying or curing, unless otherwise specified.

The term “substrate” refers to any solid surface to which the coating composition can be applied, including but not limited to mineral and non-mineral substrates, unless otherwise specified.

The term “binder” refers to a matrix-forming polymeric component that, upon drying or curing of the coating composition, forms a continuous polymer matrix (film) providing cohesion within the coating composition and adhesion to a substrate, unless otherwise specified.

The term “binder matrix” refers to the coalesced, interconnected polymer film formed by the binder after drying or curing of the coating composition, which embeds and binds the particulate material of the filler system and other coating composition components into a cohesive structure, unless otherwise specified.

The term “filler system” refers to refers to solid particulate material dispersed within the binder matrix and, in the present disclosure, comprises both a high-density inorganic filler and a low-density organic filler, unless otherwise specified.

The term “high density inorganic filler” refers to mineral-based particulate material having a bulk density of at least 0.2 g/cm³. Non-limiting examples include calcium carbonate (chalk), talc, silica, aluminosilicates, mica, barium sulfate, dolomite, kaolin, and combinations thereof, unless otherwise specified.

The term “low density organic filler” refers to a component comprising organic particulate material having a bulk density less than 0.15 g/cm³, and having solids content of at least 5% by weight, unless otherwise specified

The term “particulate material” refers to solid particles of defined average particle size and bulk density, including but not limited to hollow expanded polymer microspheres and other organic or inorganic particles suitable for use in coating compositions, unless otherwise specified.

The term “solids content” refers to a mass fraction of non-volatile material in a component or composition, expressed as weight percent relative to the total mass of that component or composition, as determined by a standard solids measurement method, unless otherwise specified.

The term “interfacial additive system” refers to a set of three or more additives that act at internal interfaces within the coating composition and/or at the interface between the coating and the substrate, including pigment-binder interfaces and coating-substrate interfaces, unless otherwise specified.

The term “adhesion promoter” refers to a component that enhances bonding between the cured coating and a substrate surface. Non-limiting examples include organosilanes, silane coupling agents, phosphate esters, titanates, zirconates, and polymer adhesion modifiers, unless otherwise specified.

The term “dispersant” refers to a component that facilitates wetting, separation, and stabilization of pigments, fillers and other components within the coating composition, thereby improving dispersion quality and preventing agglomeration, unless otherwise specified.

The term “wetting agent” refers to a surface-active component that reduces the surface tension of the liquid phase and/or the contact angle between the liquid and a solid surface, including but not limited to pigment, filler, and/or substrate surfaces, thereby promoting spreading and penetration of the coating composition, unless otherwise specified.

The term “thickener” refers to a component that increases low-shear viscosity of the coating composition, thereby influencing its storage stability, sag resistance, and leveling, unless otherwise specified.

The term “rheology modifier” refers to a component that controls viscosity and flow behavior of the coating composition over a range of shear rates, unless otherwise specified.

The term “other additives” refers to the components of the coating composition selected from biocides, preservatives, pigments, defoamers, buffers, coalescents, rust inhibitors, and other conventional coating additives known in the art, unless otherwise specified.

The term “thermal insulation properties” refers to the ability of the cured coating to reduce heat transfer through a substrate under defined heat exposure conditions. A coating composition having thermal insulation properties can reduce substrate temperature rise relative to an uncoated substrate under identical conditions, unless otherwise specified.

The term “bulk density” refers to the mass of a material divided by its bulk volume, unless otherwise specified.

The term “cured coating” refers to the solid film obtained after application and drying or curing of the coating composition under ambient or accelerated conditions, unless otherwise specified.

The term “Krebs Units” or “KU” refers to viscosity expressed in Krebs Units as measured according to ASTM D562 using a Stormer-type viscometer, unless otherwise specified.

The term “water vapor permeability” refers to the rate of water vapor transmission through the cured coating, expressed in perms and measured according to ASTM E96, unless otherwise specified.

The present invention is based on the discovery that thermal insulation properties of the coating composition and adhesion of the cured coating to multiple substrate classes can be simultaneously achieved by:

a controlled filler system utilizing a low-density organic filler with the certain characteristics;

a specific mass ratio between high density inorganic filler and low-density organic filler ranging from 0.95:1 to 1:5.5 within the filler system; and

a combination of binder and interfacial additive system in amounts sufficient to preserve a continuous polymer matrix and stable filler dispersion within the coating composition.

The first component of the filler system of the coating composition according to the present invention, which provides its thermal insulation properties is a low-density organic filler. Low density organic filler comprises particulate material having bulk density of 0.017 to 0.030 g/cm³, and an average particle size of 30 to 160 micrometers. Suitable low density organic fillers as a particulate material comprise hollow polymer microspheres, including hollow expanded polymer microspheres. Suitable low-density fillers may have solids content at least 5% wt. Preferably, the low-density filler has solids content at least 10% wt.

The low-density organic filler is present in the coating composition in an amount of 6 to 9 percent by mass of the total coating composition. Due to its extremely low bulk density (0.017-0.030 g/cm³), the low-density organic filler is the primary factor enabling the coating composition to achieve a bulk density in the range of 0.60-0.90 g/cm³. The particulate material, for example, hollow expanded polymer microspheres, introduces high volumetric contribution with minimal mass contribution, thereby lowering bulk density of the coating composition without excessive thinning of the binder matrix. At the same time, the high internal void volume of the particulate material of the low-density organic filler is important to the thermal insulation properties of the cured coating obtained from the coating composition.

The hollow microspheres provide thermal insulation properties to the coating composition due to their low thermal conductivity resulting from the gas trapped within their internal voids. The thermal conductivity of air (approximately 0.026 W/(m·K) at room temperature) is substantially lower than that of solid polymers and inorganic fillers, and incorporating a defined amount of such gas-filled hollow microspheres into the coating composition reduces the effective thermal conductivity of the cured coating obtained therefrom without requiring excessive total filler loading.

The specified size of the particulate material within the low density fille ranges from 30 to 160 micrometers, providing a balance between insulation efficiency, mechanical integrity, and processability of the coating composition.

In certain embodiments, the low-density organic filler comprises a blend of a first low density organic filler comprising first particulate material having an average particle size D1 and a second low density organic filler comprising second particulate material having an average particle size D2, wherein D1 and D2 differ by at least 40 percent. In one embodiment, the first particulate material has average particle size 40-60 um and bulk density 0.020-0.030 g/cm³ and said second particulate material has second average particle size 80-150 μm and bulk density 0.035-0.045 g/cm³. In certain embodiments the mass ratio of the first low density organic filler to the second low density organic filler is 0.8:1.2.

The use of a specified particle size distribution of the low-density organic filler increases packing efficiency of the particulate material. Smaller hollow microspheres occupy interstitial spaces between larger hollow microspheres, enabling incorporation of a higher total volume fraction of low-density organic filler while maintaining acceptable viscosity and film-forming characteristics of the coating composition. In addition, the combination of particle sizes creates a more tortuous pathway for heat transfer through the cured coating, further reducing effective thermal conductivity of the cured coating.

Experimental results demonstrate that a cured coating comprising the blend of a first low density organic filler and a second low density organic filler with the specified particle size distribution reduces substrate temperature rise by at least 15 percent more than a comparative cured coating containing only the first low density organic filler, when tested under identical heat exposure conditions.

The filler system further comprises a high-density inorganic filler, preferably having a bulk density of at least 0.2 g/cm³. The high-density organic filler is present in the coating composition in an amount of 10 to 33 percent by mass of the total coating composition. Suitable high-density fillers may have solids content at least 50% wt. Preferably, the high-density filler has solids content at least 90% wt.

Suitable high density inorganic fillers include, without limitation, talc, chalk (calcium carbonate), kaolin, silica, mica, dolomite, or combinations thereof. These materials are mineral-based particulate solids having significantly higher density than the low-density organic filler and are dispersed as rigid particles within the continuous binder matrix.

Within the coating composition and the cured coating obtained therefrom, the high-density inorganic filler performs defined structural and functional roles.

During application and drying of the coating composition layer, the high-density inorganic filler:

assists in rheological structuring of the coating composition;

reduces excessive volumetric shrinkage of the applied coating composition layer during solvent evaporation and binder coalescence;

increases load-bearing capacity

limits internal stress development prior to curing;

stabilizes spatial distribution of the low-density organic filler and reduces risk of filler segregation or migration.

In the cured coating layer, the high-density inorganic filler:

reinforces the continuous binder matrix;

increases compressive resistance and hardness of the cured coating under mechanical load;

improves scratch resistance and surface durability;

contributes to opacity and controlled light scattering within the cured coating;

distributes applied stress within the cured coating layer during bending deformation, thereby supporting claimed performance in the 1 mm cylindrical mandrel bend test.

Because the low-density organic filler comprises particulate material having a bulk density of 0.017 to 0.030 g/cm³, and average particle size of 30 to 160 micrometers, the resulting structure of the coating composition contains a high internal void fraction. While this void fraction is essential for thermal insulation, it must be mechanically stabilized. The high-density inorganic filler functions as a rigid counterbalancing phase within the structure of the coating composition. The mineral particles increase stiffness of the binder matrix and distribute applied stress through the cured coating, thereby preserving its dimensional stability and mechanical integrity without eliminating the insulating effect of the low-density organic filler.

The defined content of high-density inorganic filler provides sufficient structural reinforcement while maintaining the target bulk density and flexibility of the coating composition and the cured coating obtained therefrom.

Accordingly, the invention defines a mass ratio of high-density inorganic filler to low density organic filler of 0.95:1 to 1:5.5. This ratio establishes a controlled structure of the coating composition in which:

the low-density organic filler provides required thermal insulation properties of the coating composition;

the high-density inorganic filler provides structural reinforcement of the coating composition;

the binder maintains phase continuity and substrate adhesion of the coating composition.

The defined ratio of the components of the filler system therefore balances thermal insulation efficiency, mechanical integrity, flexibility, and adhesion performance of the coating composition across mineral and non-mineral substrates. It ensures that reinforcement is sufficient to preserve continuity of the cured coating and binder integrity without negating the insulating contribution of the low-density organic filler.

The coating composition further comprises a binder in an amount of 29 to 50 wt. % based on the total weight of the composition. A minimum binder content of 29 wt. % is desired to achieve the claimed adhesion performance and mechanical integrity of the coating composition and a cured coating obtained therefrom. Suitable binders may have solids content at least 20% wt. Preferably, the binder has solids content at least 40% wt.

The binder forms a continuous polymer matrix within the coating composition and, upon drying and curing, forms a continuous cured coating layer that:

provides cohesive strength of the cured coating;

anchors mechanically to substrate surface irregularities;

enables interfacial bonding to substrates of differing surface energies;

embeds and supports the high-density inorganic filler and the low-density organic filler within a unified structure.

Because the invention is designed to exhibit adhesion to at least two different classes of mineral and non-mineral substrates, sufficient binder content is important to provide a continuous polymer phase that fully wets the substrate surface, penetrates surface micro-irregularities, and maintains cohesive strength and flexibility of the cured coating despite the presence of the filler system in the amount of 17-45 wt. %. In relation to the specific filler system of the coating composition, the binder performs two simultaneous functions:

maintain structural continuity of the cured coating despite the presence of the particulate material having a bulk density of 0.017-0.030 g/cm³;

accommodate differential mechanical behavior between rigid mineral particles of the high-density filler and compressible hollow polymer microspheres of the low-density organic filler.

The elastic nature of the binder within the defined concentration range prevents microcrack formation that could otherwise compromise adhesion or thermal insulation properties of the coating composition. The specified binder content also can support the requirement that the cured coating passes a 1 mm cylindrical mandrel bend test without cracking or delamination.

A medium water vapor permeability of the cured coating obtained from the coating composition in the range 15-150 perms as measured by ASTM E96 enables moisture diffusion from porous mineral substrates such as concrete, brick, and cement-based substrates while maintaining adhesion and preventing blistering or delamination of the cured coating.

The coating composition further comprises an interfacial additive system in a total amount of 0.9-7 wt. % based on the total weight of the composition.

In certain embodiments, the interfacial additive system comprises at least three components selected from an adhesion promoter, a dispersant, a wetting agent, a thickener, and a rheology modifier. Suitable components of the interfacial additive system may have solids content at least 10% wt. Preferably, the components of the interfacial additive system may have solids content at least 15% wt.

The interfacial additive system cooperates with the binder to optimize interfacial interactions within the multi-phase structure of the coating composition and at the substrate interface. More importantly, for the complex filler system of the coating composition, controlled interfacial chemistry is required to maintain adhesion of the cured coating to both mineral and non-mineral substrates.

The adhesion promoter enhances interfacial bonding between the cured coating layer and the substrate surface. Suitable adhesion promoters include organosilanes, silane coupling agents, phosphate esters, titanate coupling agents, zirconate coupling agents, polymer adhesion modifiers, or combinations thereof.

The adhesion promoter functions as a molecular coupling agent that:

promotes chemical or coordinative interaction with mineral substrates;

improves compatibility between the polymer binder matrix and high-density inorganic filler surfaces;

enhances stress transfer at filler/binder interfaces;

increases resistance of the cured coating layer to peeling and delamination.

In coating composition containing hollow expanded polymer microspheres of the low-density organic filler and rigid mineral particles of the high-density inorganic filler, interfacial discontinuities may arise at phase boundaries. The adhesion promoter reduces such discontinuities by improving wetting and interfacial bonding at particle surfaces, thereby reducing weak interfacial regions within the cured coating.

The adhesion promoter is present in an amount sufficient to support adhesion performance of at least 1.1 MPa pull-off adhesion strength according to ASTM D4541 on mineral and non-mineral substrates.

In addition to substrate bonding, surface modification of filler system particles by the adhesion promoter reduces excessive particle-particle interaction and agglomeration. This contributes to stable dispersion and supports maintenance of the claimed viscosity of the coating composition in the range of 130-140 KU (ASTM D562) at the defined filler system loading.

A dispersant ensures uniform distribution of solid particles throughout the coating composition prior to curing. Suitable dispersants include polycarboxylate dispersants, phosphate ester dispersants, polymer dispersants, or combinations thereof.

The dispersant performs the following functions within the coating composition:

reduces agglomeration of high-density inorganic filler and low-density organic filler particles;

maintains homogeneous distribution of solid phases;

stabilizes the applied coating composition layer prior to drying.

Uniform dispersion is directly relevant to adhesion performance of the coating composition. Agglomerated filler particles can create localized regions of reduced binder concentration, resulting in internal stress concentration and weak cohesive zones within the cured coating. By maintaining uniform particle distribution, the dispersant supports formation of a continuous polymer matrix and reduces the likelihood of interfacial failure during pull-off adhesion strength testing.

The dispersant also contributes to rheological stability of the coating composition and assists in maintaining viscosity within the claimed range despite the presence of the filler system in the amount of 17-45% wt.

A wetting agent may be included within the interfacial additive system to reduce surface tension of the coating composition and improve spreading of the applied coating composition layer over the substrate surface. Suitable wetting agents include nonionic wetting agents, anionic wetting agents, silicone-based wetting agents, or combinations thereof.

The wetting agent performs the following functions within the coating composition:

reduces surface tension of the liquid phase, thereby improving substrate wetting;

promotes contact between the applied coating composition layer and the substrate surface;

enhances levelling and penetration of the coating composition into surface micro-irregularities;

reduces formation of surface defects such as pinholes and craters in the cured coating.

Improved wetting is particularly important for non-mineral substrates having lower surface energy, where insufficient spreading may result in incomplete surface coverage and reduced adhesion of the cured coating. The wetting agent may also assist in wetting pigment and filler system particles, thereby contributing to uniform distribution within the applied coating composition layer prior to curing.

A thickener may be included within the interfacial additive system to optimize rheological stability and application properties of the coating composition. In certain embodiments, the thickener comprises an associative thickener. Suitable associative thickeners include hydrophobically modified polymers capable of forming reversible associations within the aqueous binder matrix.

The thickener interacts with the binder matrix and dispersed solid particles of the filler to establish controlled viscosity and shear-dependent flow behavior of the coating composition. Within the applied coating composition layer, the thickener:

promotes uniform suspension and distribution of dispersed solid particles, including high density inorganic filler and low-density organic filler;

reduces sedimentation, flotation, and stratification of dispersed solid phases within the uncured coating composition during storage and handling;

provides shear-thinning behavior to facilitate application while maintaining sag resistance of the coating composition;

supports uniform layer during drying and curing of the coating composition.

By maintaining structural homogeneity of the applied coating composition layer and stabilizing the spatial distribution of the binder and filler system, the thickener supports mechanical integrity and adhesion performance of the cured coating by minimizing localized binder-deficient regions and internal structural discontinuities within the coating composition.

A rheology modifier controls viscosity and flow behavior of the coating composition and maintains the claimed viscosity of the coating composition in the range of 130-140 Krebs Units as measured by ASTM D562. Suitable rheology modifiers include cellulosic thickeners such as hydroxyethyl cellulose or methyl cellulose, polyurethane associative rheology modifiers, acrylic rheology modifiers, inorganic rheology modifiers such as bentonite or fumed silica, or combinations thereof.

Rheological control can be significant in the composition containing both high density inorganic filler and low-density organic filler having a bulk density of 0.017-0.030 g/cm³ and an average particle size of 30-160 μm. The rheology modifier provides:

High viscosity of the coating composition at low shear, contributing to suspension of both high-density inorganic filler and low-density organic filler particles;

reduced viscosity of the coating composition under application shear, enabling brush, roller, or spray application;

rapid viscosity recovery after shear removal, reducing sagging and drip of the coating composition;

uniform thickness of the applied coating composition layer;

stabilization of the filler system components ratio of 0.95:1 to 1:5.5 during storage and application of the coating composition.

Because the low-density organic filler has ultra-low bulk density, insufficient viscosity may allow flotation, migration, or stratification of the particulate material within the applied coating composition layer. Such migration may generate density gradients, localized insulation variability, or surface defects in the cured coating layer. Excessively high viscosity, conversely, may impair substrate wetting and trap air within the applied coating composition layer.

Maintaining viscosity of the coating composition within the defined range of 130-140 KU can represent a functional balance that:

stabilizes uniform distribution of both filler system components;

preserves the required bulk density of 0.60-0.90 g/cm³ in the coating composition;

supports uniform structure of the cured coating;

contributes to consistent performance of the cured coating in mandrel bend testing.

The interfacial additive system, present in a total amount of 0.9-7 wt. % of the coating composition, cooperates with the binder and filler system to regulate interfacial chemistry, dispersion stability, and flow behavior within the coating composition and the cured coating obtained therefrom.

Within the applied coating composition layer, the interfacial additive system:

improves substrate wetting and surface contact;

stabilizes dispersion of the filler system components;

maintains viscosity of the coating composition within the claimed range;

prevents phase separation or stratification of filler particles.

Within the cured coating layer, the interfacial additive system:

enhances interfacial bonding to mineral and non-mineral substrates;

reduces interfacial defects between filler system particles and the binder matrix;

supports cohesive integrity of the cured coating under mechanical deformation.

Extensive experimental evaluation has been found that the defined concentration range of 0.9-7 wt. % was sufficient for interfacial and rheological control without materially altering the bulk mechanical properties of the coating composition governed by the binder (29-50 wt. %) and the filler system (17-45 wt. %).

The thinner controls the viscosity and consistency of the coating composition. In one embodiment, the thinner comprises demineralized water. The use of demineralized water provides chemical stability and prevents unwanted interactions with other components of the coating composition.

The composition further comprises a thinner. The thinner may comprise water, including purified water, deionized water, or demineralized water. In a particular embodiment, the thinner comprises demineralized water.

Demineralized water is a preferred thinner for the claimed coating composition because it provides effective viscosity adjustment and dispersion control while substantially minimizing the presence of dissolved salts and multivalent metal ions. Reduction of ion content limits unintended interactions with the binder, inorganic filler, low density organic filler, and interfacial additive system, thereby improving storage stability, dispersion homogeneity, and reproducibility of rheological properties of the coating composition. The use of demineralized water further supports controlled pH conditions and reduces the risk of coagulation, flocculation, or destabilization of the filler system.

The thinner may be present in an amount of 9 to 30 wt. % based on the total weight of the composition. Within this range, the thinner contributes to achieving the defined viscosity range and application characteristics of the coating composition without materially altering the structural balance of the binder and filler system or compromising the targeted bulk density of the coating composition.

The composition may further comprise one or more auxiliary additives selected from a biocide, preservative, pigment, defoamer, buffer, coalescent, and rust inhibitor. Such additives may be included in amounts effective to provide microbial resistance, coloration, foam control, pH stabilization, film formation enhancement, or corrosion protection, respectively, without materially affecting the rheological and mechanical properties defined for the coating composition. In certain embodiments, multiple components of the same type may be incorporated to achieve particular functional or aesthetic effects of the coating composition.

The coating composition has a viscosity of 130 to 140 Krebs Units (KU) as measured by ASTM D562 and a bulk density of 0.60 to 0.90 g/cm³. These parameters reflect the controlled dispersion of filler system within the binder matrix and ensure suitability for spray, roll, or brush application of the coating composition. The reduced bulk density of the coating composition also contributes to ease of handling and reduced weight loading on substrates.

In certain embodiments, a cured coating obtained from a coating composition comprising a low-density organic filler consisting essentially of particulate material having a single average particle size (40-60 μm) reduces substrate temperature rise by at least 40% under identical heat exposure conditions relative to an uncoated substrate.

In certain embodiments, wherein the low-density organic filler comprises a blend of first and second particulate materials having different average particle sizes (40-60 μm and size 80-150 μm respectively), the cured coating reduces substrate temperature rise by at least 15% more than a comparative cured coating containing only one of said particulate materials with average particle sizes of 40-60 μm, when tested under identical heat exposure conditions. Temperature rise can be measured at defined time intervals using contact thermocouples, infrared thermometry, or other suitable temperature measurement methods.

The cured coating passes a 1 mm cylindrical mandrel bend test without cracking or delamination, showing that the inclusion of low-density organic filler within the defined ratio range does not compromise film flexibility. This test demonstrates compatibility with substrates subject to thermal expansion, vibration, or mechanical deformation.

In certain embodiments, the cured coating exhibits water vapor permeability of 15-150 perms as measured according to ASTM E96. This range enables controlled diffusion of water vapor through the cured coating between the coated substrate and the surrounding environment while maintaining thermal insulation properties of the coating composition.

The coating composition according to the present invention exhibits adhesion to at least two different classes of mineral and non-mineral substrates. The mineral substrate can be selected, without limitation, from concrete, cement, brick. The non-mineral substrate can be selected, without limitation, from metal substrates, polymer substrates, and wood-based substrates.

The coating composition according to the present invention is suitable for both interior and exterior applications. The coating composition may be applied by brush, roller, spray, or other conventional coating techniques. After application, the coating is allowed to dry or cure under ambient or accelerated conditions to form a continuous cured coating. The coating composition may also be applied to the previously coated substrates, including painted surfaces, primed surfaces, and sealed surfaces.

The coating composition may be applied to substrates in construction, industrial, transportation, and other applications where thermal insulation is desired. Suitable applications include, without limitation, building exteriors and interiors, storage tanks, pipelines, transportation vehicles, and equipment requiring temperature control.

The coating composition according to the present invention may be produced by combining the components in a suitable mixing vessel. In one embodiment, the coating composition having thermal insulation properties, adhesion to at least two different classes of mineral and non-mineral substrates, and a bulk density of 0.60-0.90 g/cm³ is produced by implementing a manufacturing method comprising:

(a) dispersing the high-density inorganic filler in a mixture of binder and thinner under mixing regimen A;

(b) subsequently incorporating the low-density organic filler under mixing regimen B; and

(c) adjusting rheology to obtain a viscosity of 130-140 KU as measured by ASTM D562.

Mixing may be conducted using conventional equipment, including without limitation a disperser, high-speed mixer, planetary mixer, or other suitable agitation system. Mixing speed and duration may be selected to achieve adequate dispersion and uniform distribution of components.

According to certain embodiments, mixing regimen A is characterized by an anchor agitator speed of at least 10 RPM (revolutions per minute), and milling blade speed of at least 150 RPM for at least 10 minutes. In certain embodiments, mixing regimen B is characterized by an anchor agitator speed of at least 15 RPM, and milling blade speed of at least 300 RPM for at least 10 minutes.

According to another embodiment, mixing regimen A is characterized by an anchor agitator speed of at least 10 RPM and a milling blade speed of at least 250 RPM for at least 5 minutes. In certain embodiments, mixing regimen B is characterized by an anchor agitator speed of at least 10 RPM and a milling blade speed of at least 250 RPM for at least 5 minutes.

The foregoing manufacturing procedure is provided as a representative, non-limiting example. Additional components of the coating composition, including optional pigments and other additives, may be introduced at any suitable stage of the mixing process. Furthermore, additional processing steps may be performed as necessary, including but not limited to premixing, staged addition of components, temperature control, deaeration, filtration, milling, post-adjustment of viscosity, or other conventional coating manufacturing operations. Variations in mixing order, shear profile, duration, and equipment configuration may be implemented provided that the resulting composition exhibits the properties defined herein.

### EXAMPLES

The following examples illustrate representative embodiments of the invention and are not intended to limit the scope thereof.

### Example 1

### Method of Preparation of the Coating Composition

The filler system is up to 32% wt. of the coating composition according to this example and comprises the high-density inorganic filler 14% wt. and low-density organic filler 18% wt. with the mass ratio of high-density inorganic filler to low density organic filler of 1:1.29.

Add to a stainless-steel mixing vessel equipped with a high-speed disperser thinner 23.0% wt. and interfacial additive system 3.0% wt. Mix at 600 rpm for 10 min.

Increase the speed to 1100 rpm. Add the high-density inorganic filler 14% wt. of the filler system. Mix for 20 min.

Reduce the speed to 600 rpm. Add the binder 42% wt. Mix for 15 min until smooth.

Reduce the speed to 300 rpm. Add the low-density organic filler 18% wt. with average particle size of 50 um. Mix for 20 min. Mix for 10 min without excessive shear to avoid damaging the low-density organic filler.

Check the bulk density for compliance to 0.6-0.9 g/cm³, and viscosity for compliance to 130 to 140 KU.

Filter the resultant coating composition through 150 micron mesh. Pour the filtered coating composition into suitable containers. Condition for 24 hours to stabilize rheological properties.

### Example 2

### Method of Preparation of the Coating Composition

In a clean container, add the thinner 21.14% wt., the wetting agent 0.07% wt., the thickener 0.2% wt., the dispersant 0.2% wt., the defoamer 0.15% wt., and the biocides 0.084% wt. Mix for 10 min at ~800 rpm until complete dissolution.

Gradually add the pigments 11% wt., and the high-density inorganic fillers 11.5% wt. Increase the speed to 1650 rpm. Mix for 30 min.

Reduce the speed to 600 rpm. Slowly add the binder 41% wt. Mix for 15 min until smooth.

At 500 rpm, sequentially add the coalescent 1.5% wt., rust inhibitor 0.5% wt., the adhesion promoter 0.5% wt., the buffer 0.106% wt., the rest of the defoamer 0.15% wt., and additional thinner 2% wt. Mix for 10 min.

Increase the speed to 1650 rpm. Add the rheology modifiers 1.9% wt. Mix for 20 min until viscosity stabilizes at 130-140 KU.

Reduce the speed to 300 rpm. Add the low-density organic filler 8% wt. Mix for 10 min without excessive shear to avoid damaging the low-density organic filler.

Check the bulk density for compliance to 0.75 g/cm³, and viscosity for compliance to 130 to 140 KU.

Filter the resultant coating composition through 150 micron mesh. Pour the filtered coating composition into suitable containers. Condition for 24 hours to stabilize rheological properties.

### Example 3

### Method of Preparation of the Coating Composition

In a clean container, add the thinner 13.24% wt., the wetting agent 0.03% wt., the thickener 0.075% wt., the dispersant 0.152% wt., the defoamer 0.075% wt., and the biocides 0.078% wt. Mix for 10 min at ~800 rpm until complete dissolution.

Gradually add the pigments 10.5% wt., and the high-density inorganic fillers 17.3% wt. Increase the speed to 1650 rpm. Mix for 30 min.

Reduce the speed to 600 rpm. Slowly add the binder 45.1% wt. Mix for 15 min until smooth.

(a) At 500 rpm, sequentially add the coalescent 0.75% wt., rust inhibitor 0.45% wt., the adhesion promoter 0.15% wt., the buffer 0.075% wt., the rest of the defoamer 0.075% wt., and additional thinner 2% wt. Mix for 10 min.

Increase the speed to 1650 rpm. Add the rheology modifiers 0.95% wt. Mix for 20 min until viscosity stabilizes at 130-140 KU.

Reduce the speed to 300 rpm. Add the low-density organic filler 9% wt. Mix for 10 min without excessive shear to avoid damaging the low-density organic filler.

Check the bulk density for compliance to 0.6 g/cm³, and viscosity for compliance to 130 to 140 KU.

Filter the resultant coating composition through 150 micron mesh. Pour the filtered coating composition into suitable containers. Condition for 24 hours to stabilize rheological properties.

### Example 4

### Method of Preparation of the Coating Composition

In a clean container, add the thinner 6.7% wt., the wetting agent 0.17% wt., the thickener 0.25% wt., the dispersant 0.25% wt., the defoamer 0.19% wt., and the biocides 0.09% wt. Mix for 10 min at ~800 rpm until complete dissolution.

Gradually add the pigments 14.95% wt., and the high-density inorganic fillers 17.03% wt. Increase the speed to 1650 rpm. Mix for 30 min.

Reduce the speed to 600 rpm. Slowly add the binder 45.1% wt. Mix for 15 min until smooth.

At 500 rpm, sequentially add the coalescent 1.56% wt., rust inhibitor 0.93% wt., the adhesion promoter 0.62% wt., the buffer 0.16% wt., the rest of the defoamer 0.19% wt., and additional thinner 2% wt. Mix for 10 min.

Increase the speed to 1650 rpm. Add the rheology modifiers 2.8% wt. Mix for 20 min until viscosity stabilizes at 130-140 KU.

Reduce the speed to 300 rpm. Add the low-density organic filler 7.5% wt. Mix for 10 min without excessive shear to avoid damaging the low-density organic filler.

Check the bulk density for compliance to 0.9 g/cm³, and viscosity for compliance to 130 to 140 KU.

Filter the resultant coating composition through 150 micron mesh. Pour the filtered coating composition into suitable containers. Condition for 24 hours to stabilize rheological properties.

### Example 5-16

### Method of Preparation of the Coating Composition

For brevity purposes, in Table 1 below are exemplary formulations of the coating compositions according to the invention. The method of preparation is the same as for Examples 1-3.

TABLE 1
Exemplary formulations of the coating compositions

| | Example # | | | | | | | | | | | |
|---|---|---|---|---|---|---|---|---|---|---|---|---|
| Component | 5 | 6 | 7 | 8 | 9 | 10 | 11 | 12 | 13 | 14 | 15 | 16 |
| Binder | 40.37 | 39.75 | 48.8 | 36.42 | 33.95 | 49.35 | 29.60 | 46.18 | 29.25 | 37.58 | 44.68 | 43.60 |
| Filler | 34.62 | 24.60 | 26.35 | 19.70 | 44.1 | 17.40 | 39.85 | 28.40 | 18.60 | 41.30 | 31.2 | 22.85 |
| system | | | | | | | | | | | | |
| Thinner | 21.4 | 16.80 | 19.72 | 14.95 | 18.6 | 18.20 | 27.9 | 19.90 | 19.70 | 18.75 | 13.90 | 16.4 |
| Interfacial | 2.61 | 3.05 | 5.13 | 4.83 | 3.36 | 5.05 | 19.9 | 5.52 | 3.95 | 2.37 | 4.22 | 3.15 |
| additive | | | | | | | | | | | | |
| system | | | | | | | | | | | | |
| Pigment | 0.00 | 15.8 | 0.00 | 24.10 | 0.00 | 10.00 | 0.00 | 0.00 | 28.50 | 0.00 | 6.00 | 14.00 |

### Example 17

### Method of Large-Scale Manufacturing of the Coating Composition

Below is an exemplary method for large-scale manufacturing of the coating composition according to the invention.

In a stainless-steel mixing vessel with cooling jacket, add the thinner demineralized water 129.7 kg first, then add the high-density inorganic fillers talc 40 kg, calcium carbonate 175 kg. Disperse at mixing regimen A, namely anchor agitator speed of at least 10 RPM and milling blade speed of at least 150 RPM for 20 minutes. Subsequently add the styrene-acrylic dispersion 410 kg with continued mixing regimen A.

Add the low-density organic filler comprising hollow expanded polymer microspheres having average particle size 40-60 μm and bulk density 0.020-0.030 g/cm³ 80 kg. Mix at mixing regimen B, namely anchor agitator speed of at least 15 RPM and milling blade speed of at least 300 RPM for 10 minutes.

Adjust the rheology to provide a viscosity of 130-140 KU as measured by ASTM D562 using the wetting agent 2 kg, the dispersant 2 kg, the clay rheology modifier 5.5 kg, cellulosic thickener 2.2 kg, associative thickener 13.5 kg. Mix for 25 min until viscosity stabilizes at 130-140 KU.

Check the bulk density for compliance to 0.75 g/cm³, and viscosity for compliance to 130 to 140 KU, and appearance for compliance to be uniform.

Filter the resultant coating composition through 150 micron mesh. Pour the filtered coating composition into paint buckets to obtain a batch of 1 000 buckets. Condition for 24 hours to stabilize rheological properties.

### Example 18

### Method of Large-Scale Manufacturing of the Coating Composition

In a stainless-steel mixing vessel with cooling jacket, add the thinner demineralized water 80 kg, the wetting agent sodium tripolyphosphate 0.2 kg, the wetting agent 0.5 kg, the dispersant 1 kg, the defoamer 0.5 kg, and the biocides 0.02 kg and 0.5 kg. Mix for 15 min with a Cowles type high-speed disperser at 700 rpm until complete dissolution and a homogeneous phase is obtained.

Gradually add the titanium dioxide pigment 60 kg, zinc oxide pigment 10 kg, and the high-density inorganic fillers talc 15 kg, calcium carbonate 100 kg. Increase the speed of the Cowles type high-speed disperser to 1650 rpm. Mix for 35 min until there are no visible agglomerates.

Reduce the speed of the Cowles type high-speed disperser to 600 rpm. Slowly add the binder styrene-acrylic dispersion 300 kg during 20 min to avoid shock flocculation. Mix for 20 min until a uniform, lump-free dispersion is obtained.

At 500 rpm, sequentially add the rust inhibitor 3 kg, the organosilane adhesion promoter 1 kg, the buffer monoisopropanolamine 0.5 kg, the rest of the defoamer 0.5 kg, and additional thinner demineralized water 20 kg. Mix for 15 min after addition of the final component.

Increase the speed to 1650 rpm. Add the clay rheology modifier 2 kg, cellulosic thickener 1 kg, associative thickener 3.5 kg. Mix for 25 min until viscosity stabilizes at 130-140 KU. Allow 10 minutes for full hydration of the rheology modifiers before final viscosity adjustment.

Reduce the speed to 300 rpm. Add the low-density organic filler comprising a blend of a first low density organic filler comprising first particulate material having average particle size 40-60 um and bulk density 0.020-0.030 g/cm³ 30 kg and second low density organic filler comprising second particulate material having second average particle size 80-150 um and bulk density 0.035-0.045 g/cm³. Mix for 10 min under low shear to avoid structural damage to the low-density organic filler particulate material.

Check the bulk density for compliance to 0.65 g/cm³, and viscosity for compliance to 130 to 140 KU, and appearance for compliance to be uniform.

Filter the resultant coating composition through 150 micron mesh. Pour the filtered coating composition into 10 L buckets to obtain a batch of 1 000 buckets. Condition for 24 hours to stabilize rheological properties.

### Example 19

### Method of Large-Scale Manufacturing of the Coating Composition

In a stainless-steel mixing vessel with cooling jacket, add the thinner demineralized water 300 kg, the wetting agent sodium tripolyphosphate 2.5 kg, the wetting agent 4 kg, the dispersant 4 kg, the defoamer 6 kg, and the biocides 0.06 kg and 1.5 kg. Mix for 15 min with a Cowles type high-speed disperser at 700 rpm until complete dissolution and a homogeneous phase is obtained.

Gradually add the titanium dioxide pigment 200 kg, zinc oxide pigment 40 kg, and the high-density inorganic fillers talc 80 kg, calcium carbonate 250 kg. Increase the speed of the Cowles type high-speed disperser to 1650 rpm. Mix for 35 min until there are no visible agglomerates.

Reduce the speed of the Cowles type high-speed disperser to 600 rpm. Slowly add the binder acrylic dispersion 500 kg during 20 min to avoid shock flocculation. Mix for 20 min until a uniform, lump-free dispersion is obtained.

At 500 rpm, sequentially add the rust inhibitor 15 kg, the organosilane adhesion promoter 10 kg, and the buffer monoisopropanolamine 2.5 kg. Mix for 15 min after addition of the final component.

Increase the speed to 1650 rpm. Add the clay rheology modifier 6 kg, cellulosic thickener 4 kg, associative thickener 35 kg. Mix for 25 min until viscosity stabilizes at 130-140 KU. Allow 10 minutes for full hydration of the rheology modifiers before final viscosity adjustment.

Reduce the speed to 300 rpm. Add the low-density organic filler comprising particulate material with average particle size 40-60 μm and bulk density 0.020-0.030 g/cm3 120 kg. Mix for 10 min under low shear to avoid structural damage to the low-density organic filler particulate material.

Check the bulk density for compliance to 0.85 g/cm³, and viscosity for compliance to 130 to 140 KU, and appearance for compliance to be uniform.

Filter the resultant coating composition through 150 micron mesh. Pour the filtered coating composition into 10 L buckets to obtain a batch of 1 000 buckets. Condition for 24 hours to stabilize rheological properties.

### Examples 20

### Method of Preparation of the Coating Composition

For brevity purposes, in Table 2 below are exemplary formulations of the coating compositions according to the invention. The method of preparation is the same as for Examples 1-3.

TABLE 2
Exemplary formulations of the coating compositions

| | Example # | | | | | | | | | | | |
|---|---|---|---|---|---|---|---|---|---|---|---|---|
| Component | 20 | 21 | 22 | 23 | 24 | 25 | 26 | 27 | 28 | 29 | 30 | 31 |
| Acrylic | 32.5 | 0.0 | 44.0 | 0.0 | 46.5 | 44.5 | 46.5 | 0.0 | 46.6 | 0.0 | 46.5 | 46.6 |
| dispersion | | | | | | | | | | | | |
| Styrene-acrylic | 0.0 | 46.5 | 0.0 | 44.5 | 0.0 | 0.0 | 0.0 | 46.5 | 0.0 | 47.5 | 0.0 | 0.0 |
| dispersion | | | | | | | | | | | | |
| Hollow | 14.0 | 22.8 | 17.6 | 15.6 | 9.5 | 22.7 | 21.2 | 21.3 | 22.7 | 19.6 | 18.6 | 18.9 |
| expanded | | | | | | | | | | | | |
| polymer | | | | | | | | | | | | |
| microspheres | | | | | | | | | | | | |
| 50 μm | | | | | | | | | | | | |
| Hollow | 8.5 | 0.0 | 0.0 | 9.1 | 12.6 | 0.0 | 0.0 | 0.0 | 0.0 | 9.8 | 0.0 | 0.0 |
| expanded | | | | | | | | | | | | |
| polymer | | | | | | | | | | | | |
| microspheres | | | | | | | | | | | | |
| 100 μm | | | | | | | | | | | | |
| Talc | 18.0 | 16.2 | 22.5 | 17.8 | 14.4 | 19.6 | 18.3 | 15.9 | 13.7 | 17.0 | 21.8 | 20.2 |
| Associative | 0.0 | 1.2 | 1.4 | 0.8 | 0.0 | 1.1 | 1.3 | 0.9 | 1.0 | 1.5 | 0.0 | 1.2 |
| thickener | | | | | | | | | | | | |
| Organosilane | 1.8 | 2.0 | 0.0 | 1.5 | 2.1 | 0.0 | 1.9 | 2.2 | 0.0 | 1.7 | 2.3 | 0.0 |
| adhesion | | | | | | | | | | | | |
| promoter | | | | | | | | | | | | |
| Surface wetting | 0.9 | 1.1 | 0.0 | 1.0 | 0.0 | 1.3 | 1.0 | 0.0 | 1.2 | 0.0 | 1.4 | 1.1 |
| agent | | | | | | | | | | | | |
| Sodium | 0.6 | 0.7 | 0.9 | 0.0 | 0.7 | 0.8 | 0.0 | 1.0 | 0.0 | 0.9 | 0.0 | 0.7 |
| tripolyphosphate | | | | | | | | | | | | |
| Clay rheology | 1.2 | 1.5 | 0.0 | 1.1 | 1.6 | 0.0 | 1.3 | 1.4 | 0.0 | 1.2 | 1.7 | 0.0 |
| modifier | | | | | | | | | | | | |
| Texanol | 0.0 | 4.5 | 3.8 | 0.0 | 5.2 | 4.1 | 0.0 | 3.6 | 4.8 | 0.0 | 3.9 | 0.0 |
| Pigment | 0.5 | 0.0 | 6.5 | 0.0 | 8.2 | 0.0 | 5.9 | 0.0 | 7.4 | 0.0 | 6.8 | 0.0 |
| Biocide | 0.0 | 0.0 | 0.0 | 0.6 | 0.8 | 0.0 | 0.9 | 0.5 | 0.0 | 0.7 | 0.6 | 0.0 |
| Defoamer | 0.3 | 0.0 | 0.4 | 0.0 | 0.5 | 0.0 | 0.6 | 0.0 | 0.7 | 0.0 | 0.5 | 0.0 |
| Buffer | 0.0 | 0.6 | 0.0 | 0.7 | 0.0 | 0.8 | 0.0 | 0.9 | 0.0 | 1.0 | 0.0 | 0.6 |
| Rust inhibitor | 0.4 | 0.7 | 0.0 | 0.5 | 0.9 | 0.0 | 0.8 | 0.6 | 0.0 | 0.7 | 0.5 | 0.0 |

### Example 32

### Assessment of the Adhesion of the Cured Coating to Different Substrates

The assessment was performed using Method A of the ASTM D3359-23 (while designed for metal substrates, it can be extended to plastics, wood, composites, etc.). This test method was used to evaluate whether the adhesion of the cured coating to different metal substrates was adequate for the application.

The tools and procedures steps were the same as for the Example 8, the difference laid in the test substrates that were as follows:

an organic plaster plate coated with the coating composition according to the Example 2 and cured to complete dryness for 24 hours,

a polycarbonate plate coated with the coating composition according to the Example 2 and cured to complete dryness for 24 hours,

a solid wood plate coated with the coating composition according to the Example 2 and cured to complete dryness for 24 hours,

a laminated panel plate coated with the coating composition according to the Example 2 and cured to complete dryness for 24 hours,

a float glass plate coated with the coating composition according to the Example 2 and cured to complete dryness for 24 hours,

a roofing felt plate coated with the coating composition according to the Example 2 and cured to complete dryness for 24 hours,

a polyurethane foam board plate coated with the coating composition according to the Example 2 and cured to complete dryness for 24 hours.

The test was performed 6 times for each of the test specimens, and the average values were calculated. The results are summarized in the Table 3.

TABLE 3
Assessment of the adhesion of the cured
coating to different substrates

| Test specimen | Adhesion rate |
|---|---|
| Organic plaster | 5A |
| Polycarbonate | 4A |
| Solid wood | 5A |
| Laminated panel | 4A |
| Float glass | 4A |
| Roofing felt | 5A |
| Polyurethane foam board | 5A |

### Example 33

### Assessment of the Adhesion of the Cured Coating to Different Substrates

The assessment was performed using a technique described in the ASTM D4541-17. This test method was used to evaluate the pull-off strength of the cured coating from different classes of mineral and non-mineral substrates.

For the test, the following tools and materials were used:

an adhesion tester PosiTest AT from DeFelsko Corporation to determine the maximum perpendicular tensile force required to detach the coating from the substrate

surface,

a timer,

a solvent to clean the loading fixture surface,

sandpaper,

glue to secure the loading fixture to the surface,

mechanical clamps to hold the fixture in place while the glue cures,

cotton swabs to remove excess glue.

The test substrates that were as follows:

a concrete plate coated with the coating composition according to the Example 2 and cured to complete dryness for 24 hours,

a cement plate coated with the coating composition according to the Example 2 and cured to complete dryness for 24 hours,

a brick plate coated with the coating composition according to the Example 2 and cured to complete dryness for 24 hours,

a steel plate coated with the coating composition according to the Example 2 and cured to complete dryness for 24 hours,

a polyvinyl chloride (PVC) plate coated with the coating composition according to the Example 2 and cured to complete dryness for 24 hours,

a plywood plate coated with the coating composition according to the Example 2 and cured to complete dryness for 24 hours.

Each substrate plate was degreased and prepared to being coated with the coating composition according to standard surface preparation procedures.

To prepare the test samples, the surface of the cured coating was slightly abraded to promote adhesion of the glue to the surface of the cured coating. Then, the area on the cured coating was cleaned to remove particulates after abrading. To ensure cleanliness, the solvent was used to remove all contaminants left.

The adhesive was prepared in accordance with the adhesive manufacturer's recommendations. Then, the adhesive was applied to the surface of the cured coating to be tested using a method and thickness recommended by the adhesive manufacturer.

The dolly was positioned on the surface of the cured coating to be tested. Any excess glue was carefully removed from around the dolly avoiding any twisting. The glue was cured for 24 hours based on the glue manufacturer's recommendations. A constant contact pressure was maintained on the dolly during the glue set and cure step using mechanical clamps.

Testing was performed by applying a perpendicular tensile force to the fixture until detachment of the cured coating occurred. To accomplish this, the tester was then attached to the dollies, and a steadily increasing tensile load was applied perpendicular to the panel surface until the cured coating failure occurred, defined as detachment of the cured coating from the substrate or cohesive failure within the cured coating layer itself.

Pull-off adhesion values were recorded in units of pressure expressed in MPa for each substrate type.

The test was performed 6 times for each of the test specimens, and the average values were calculated. The results are summarized in the Table 4.

TABLE 4
Assessment of the adhesion of the cured
coating to different substrates

| | Cured coating | Pull-Off |
|---|---|---|
| Test specimen | thickness (mm) | Strength (MPa) |
| Concrete | 2 | 3.0 |
| Concrete | 4 | 2.5 |
| Cement | 2 | 2.8 |
| Cement | 4 | 2.2 |
| Brick | 2 | 2.6 |
| Brick | 4 | 2.1 |
| Steel | 2 | 3.4 |
| Steel | 4 | 3.2 |
| PVC | 2 | 2.2 |
| PVC | 4 | 1.8 |
| Plywood | 2 | 2.5 |
| Plywood | 4 | 2.0 |

All tested specimens exhibited measurable pull-off adhesion values, demonstrating that the coating composition according to Example 2 provides effective adhesion across different classes of mineral and non-mineral substrates.

### Example 35

### Assessment of the Flexibility of the Cured Coating on the Metal Substrates

The assessment was performed using the Method B described in the ASTM D522/D522M-17. This test method was used to evaluate the flexibility (resistance to cracking) of the cured coating on the different metal substrates.

The coating composition according to Example 2 was applied at uniform thickness to the following metal strips 0.6 mm stick, 100 mm in width and 150 mm in length:

carbon steel strip,

galvanized steel strip,

stainless steel strip,

aluminum alloy strip,

copper alloy strip,

zinc alloy strip.

After drying the coated strips were conditioned for 24 hours at 23±2° C. and 50±5% relative humidity (RH) and were bent over the standard cylindrical mandrels of diameters of 25 mm, 19 mm, 12.7 mm, 9.5 mm, 6.4 mm, 3.2 mm, and 1 mm in the same environment.

The strips were immediately removed and examined for cracking visible to the unaided eye after testing on each cylindrical mandrel.

Each test specimen was evaluated six times under identical conditions. In all six evaluations for each strip type, no visible cracking was observed. The results are summarized in Table 5.

TABLE 5
Assessment of flexibility of the cured
coating on the metal substrates

| Test specimen | Cracking |
|---|---|
| Carbon steel | No |
| Galvanized steel | No |
| Stainless steel | No |
| Aluminum alloy | No |
| Copper alloy | No |
| Zinc alloy | No |

There was no visible cracking even after testing on the cylindrical mandrel of the smallest diameter.

### Example 36

### Assessment of the Vapor Permeability of the Cured Coating

The assessment was performed according to the gravimetric cup method described in the ASTM E96/E96M-22a. This test method was used to evaluate the water vapor transmission rate of the cured coating.

For the test, the following tools and materials were used:

a test dish made of glass material with a mouth of 3000 mm²,

a test chamber with a controlled temperature and relative humidity (23° C. and 50% RH),

an electronic analytical balance,

a thickness measuring gage with accuracy of 0.0025 mm,

distilled water,

a wax sealant to attach test specimens to the test dish,

plastic films made of high-density polyethylene (PE-HD) to prepare self-supporting cured coatings.

The test specimens were the following:

a cured coating according to Example 2,

a cured coating according to Example 3,

a cured coating according to Example 4.

The test specimens were cured coatings prepared on the plastic film made of high-density polyethylene (PE-HD), free from surface defects, from which the test specimens were easily detached after drying for 28 days with free circulation of air at (23±2)° C. and (50±5) % RH. The surface area of the free film was 60 cm².

The water vapor transmission rate is influenced by the volatile and/or water-soluble components of the coating composition. Since in practice these components can evaporate from the coating composition during outdoor exposure or be washed out by water (rain), the cured coatings were aged prior to the determination of the water vapor transmission rate by subjecting the test specimens to 3 cycles comprising the following conditions:

24 h storage in water (potable water) of (23±2)° C.;

24 h drying at (50±2)° C.

After aging, the test specimens were conditioned in the standard atmosphere as (23±2)° C. and (50±5) % RH for 24 hours.

All the test specimens were tested together with the control blank specimen.

The average thickness of the cured coating was determined using a digital micrometer after complete curing, with measurements taken at five evenly distributed points per specimen and averaged.

The test dish was filled with distilled water such that the water surface was positioned 19±6 mm below the specimen in accordance with ASTM E96 (water method). The specimens were sealed to the dish using wax sealant and placed in a controlled environment at 23° C. and 50% RH on a horizontal surface. Vapor permeability was calculated in perms based on steady-state mass change over time. The results are summarized in Table 6.

TABLE 6
Assessment of vapor permeability of the cured coating

| | Vapor permeability, |
|---|---|
| Test specimen | perms |
| Example 2 | 2.6 |
| Example 3 | 2.3 |
| Example 4 | 3.0 |

The results show that the average water vapor permeability of the cured coating according to Example 2-4 was no higher than 3.0 perms that corresponds to high permeability of the cured coating.

### Example 37

### Assessment of the Thermal Conductivity of the Cured Coating

The assessment was performed according to the method described in the ASTM C518-15. This test method was used to evaluate the thermal conductivity of the cured coating.

For the test, the following tools and materials were used:

steel rule graduated to 1 mm,

electronic digital scale,

Holometrix micromet Lambda 2000 series heat flow meter.

The test specimens were the following:

cured coatings according to Example 2-4.

The test specimens were three films cured coatings prepared on the plastic film made of high-density polyethylene (PE-HD), free from surface defects, from which the test specimens were easily detached after drying for 28 days with free circulation of air at (23±2)° C. and (50±5) % RH. The surface area of each free film was 60 cm².

The specimen thickness was determined in the heat flow apparatus.

305 mm*305 mm specimens were tested at a mean temperature of 23±2° C. The recorded results are shown in the Table 7.

TABLE 7
Assessment of thermal conductivity of the cured coating

| | Thermal conductivity |
|---|---|
| Test specimen | (k, W/m · K) |
| Example 2 | 0.65 |
| Example 3 | 0.62 |
| Example 4 | 0.68 |

The results show that the cured coatings demonstrate low thermal conductivity.

### Example 38

### Assessment of the Thermal Conductivity of the Cured Coating

The assessment was performed according to the method described in the ASTM C518-15. This test method was used to evaluate the thermal conductivity of the cured coating obtained from the coating composition according to the present invention.

For the test, the following tools and materials were used:

steel rule graduated to 1 mm,

electronic digital scale,

Holometrix micromet Lambda 2000 series heat flow meter.

The test specimens were the following:

Substrates with cured coating obtained from the coating composition prepared according to Example 2.

The test specimens were cured coatings on the different substrates prepared and allowed to dry for 28 days with free circulation of air at (23±2)° C. and (50±5) % RH.

The specimens were tested at a mean temperature of 23±2° C. The recorded results are shown in the Table 8.

TABLE 8
Assessment of thermal conductivity of the
cured coating on the different substrates

| | | Thermal |
|---|---|---|
| | Cured coating | conductivity |
| Test specimen | thickness (mm) | (k, W/m · K) |
| Concrete | 2 | 0.065 |
| Concrete | 4 | 0.072 |
| Cement | 2 | 0.068 |
| Cement | 4 | 0.075 |
| Brick | 2 | 0.070 |
| Brick | 4 | 0.078 |
| Steel | 2 | 0.062 |
| Steel | 4 | 0.068 |
| PVC | 2 | 0.065 |
| PVC | 4 | 0.072 |
| Plywood | 2 | 0.070 |
| Plywood | 4 | 0.075 |

The results show that the cured coatings demonstrate low thermal conductivity. The results confirm that the cured coating obtained from the coating composition according to the present invention forms a continuous layer with stable thermal insulation properties across different classes of substrates and thicknesses of the coating composition layer.

### Example 39

### Assessment of the Performance of the Cured Coating

The assessment was performed according to the method adopted from ASTM C177-13. This test method was used to evaluate determine and compare the steady-state temperature response of:

a metal substrate coated with a cured coating according to Example 2,

a metal substrate coated with a cured coating according to Example 18, and

an uncoated metal substrate.

A controlled heat source applies thermal energy to the bottom side of the metal substrates. Heat propagates through the metal substrates, and the surface temperature on the top side is measured.

The specimens were prepared similar to Example 14. For each specimen 3 experiments were run. The average results are shown in the Table 9.

TABLE 9
Assessment of the thermal insulation
properties of the cured coating

| | Temperature, ° C. | | |
|---|---|---|---|
| Test specimen | 0 sec | 30 sec | 60 sec |
| Metal substrate | 19 | 40 | 52 |
| Metal substrate | 19 | 26 | 25 |
| coated with | | | |
| Example 2 | | | |
| Metal substrate | 19 | 25 | 24 |
| coated with | | | |
| Example 18 | | | |

The results show excellent thermal insulation properties of the cured coating obtained from the coating composition. The average decrease in temperature was 55%.

1. A coating composition with thermal insulation properties exhibiting adhesion to at least two different classes of mineral and non-mineral substrates, comprising:
a binder 29-50% wt.;
a filler system 17-45% wt.;
a thinner 9-30% wt.;
an interfacial additive system 0.9-7% wt.;
optionally 0-30% wt. of a pigment; and
0-10% wt. other additives;
wherein said filler system comprises:
a high density inorganic filler and la low density organic filler with the mass ratio of high density inorganic filler to low density organic filler 0.95:1 to 1:5.5,
the low-density organic filler comprises particulate material with a bulk density of 0.017-0.030 g/cm³ and average particle size 30-160 μm, wherein said composition has a viscosity of 130 to 140 KU as measured by ASTM D562, has a bulk density of 0.60-0.90 g/cm³, and a cured coating obtained therefrom passes the 1 mm cylindrical mandrel bend test as defined herein without cracking or delamination.

2. The composition of claim 1, wherein said high density inorganic filler has a bulk density of at least 0.2 g/cm³.

3. The composition of claim 2, wherein said high density inorganic filler comprises, without limitation, talc, chalk, kaolin, silica, mica, dolomite, or combination thereof.

4. The composition of claim 1, wherein said interfacial additive system comprises at least three components selected from an adhesion promoter, a dispersant, a wetting agent, a thickener, and a rheology modifier.

5. The composition of claim 1, wherein said composition as said other additives comprise at least one component selected from a biocide, a preservative, a pigment, a defoamer, a buffer, a coalescent, and a rust inhibitor.

6. The composition of claim 1, wherein said particulate material is hollow expanded polymer microspheres.

7. The composition of claim 6, wherein said particulate material has average particle size 40-60 μm and bulk density 0.020-0.030 g/cm³.

8. The composition of claim 1, wherein the cured coating obtained from said coating composition reduces substrate temperature rise by at least 40% under identical heat exposure conditions relative to an uncoated substrate.

9. The composition of claim 1, wherein said low density organic filler comprises a blend of a first low density organic filler comprising first particulate material having an average particle size D1 and a second low density organic filler comprising second particulate material having an average particle size D2, wherein D1 and D2 differ by at least 40%.

10. The composition of claim 1, wherein said first particulate material has average particle size 40-60 μm and bulk density 0.020-0.030 g/cm³ and said second particulate material has second average particle size 80-150 um and bulk density 0.035-0.045 g/cm³.

11. The composition of claim 9, wherein said low density organic filler comprises a blend of a first low density organic filler and a second low density organic filler with the mass ratio of the first low density organic filler to the second low density organic filler is 0.8:1.2.

12. The coating composition of claim 9, wherein the low-density organic filler comprises a blend of a first low density organic filler and a second low organic density filler, and the cured coating obtained from said coating composition reduces substrate temperature rise by at least 15% more than a comparative cured coating containing only the first low density organic filler, when tested under identical heat exposure conditions.

13. The composition of claim 1, wherein the cured coating obtained from said coating composition exhibits a water vapor permeability of 15-150 perms as measured by ASTM E96.

14. The composition of claim 1, wherein said mineral substrate is selected, without limitation, from concrete, cement, brick.

15. The composition of claim 1, wherein said non-mineral substrate is selected, without limitation, from metal substrates, polymer substrates, and wood-based substrates.

16. The composition of claim 1, wherein said composition is formulated for use in both interior and exterior applications.

17. A method for manufacturing coating composition with thermal insulation properties exhibiting adhesion to at least two different classes of mineral and non-mineral substrates, and a bulk density of 0.60-0.90 g/cm³, the method comprising the steps of:
(a) dispersing the high-density inorganic filler in the binder and thinner mixture at mixing regimen A;
(b) subsequently adding the low-density organic filler at mixing regimen B; and
(c) adjusting the rheology to provide a viscosity of 130-140 KU as measured by ASTM D562.

18. The method of claim 17, wherein said mixing regimen A is characterized by anchor agitator speed of at least 10 RPM, and milling blade speed of at least 150 RPM for at least 10 minutes.

19. The method of claim 17, wherein said mixing regimen B is characterized by anchor agitator speed of at least 15 RPM, and milling blade speed of at least 300 RPM for at least 10 minutes.
